(19) United States
(12) Patent Application Publication
(10) Pub. No.: US 2023/0015285 A1
(43) Pub. Date: Jan. 19, 2023

(54) ARTICLE HAVING A ONE-LAYER OR MULTI-LAYER MAIN BODY WITH ELASTIC PROPERTIES, METHOD FOR PRODUCING AN ARTICLE AND USE OF ALUMINIUM HYDROXIDE AS REINFORCING FILLER IN A RUBBER MIXTURE

(71) Applicant: GMT GUMMI-METALL-TECHNIK GMBH, BÜHL (DE)

(72) Inventors: HEIKO MÜLLER, HEYERODE (DE); MARCUS PICKARD, BÜHL (DE)

(73) Assignee: GMT GUMMI-METALL-TECHNIK GMBH, BÜHL (DE)

(21) Appl. No.: 17/786,920

(22) PCT Filed: Dec. 18, 2020
(86) PCT No.: PCT/EP2020/087103

§ 371 Date: Jun. 17, 2022

(30) Foreign Application Priority Data
Dec. 20, 2019 (DE) 10 2019 135 450.1

(51) Int. Cl. C08K 3/04; C08K 3/22; B32B 25/04; B32B 25/16; B32B 25/02; F16F 9/05; F16F 9/04

(52) U.S. Cl. CPC C08K 3/04; C08K 3/22; B32B 25/042; B32B 25/16; B32B 25/02; F16F 9/05; F16F 9/0409; C08K 2003/2241; C08K 2003/2265; C08K 2003/2227; C08K 2201/019; C08K 2201/006; B32B 2250/248; B32B 2250/40; B32B 2260/02; B32B 2260/04; B32B 2270/00; B32B 2307/3065; B32B 2307/56; F16F 2224/025; F16F 2226/04; F16F 2222/126; F16F 2230/40

(57) ABSTRACT

The invention relates to an article, more particularly an air spring bellows, having a one-layer or multi-layer main body with elastic properties, at least one layer of the main body being made up of a rubber mixture, a carbon black proportion of at least one carbon black, more particularly a total carbon black proportion of all carbon blacks, of the rubber mixture being less than 5 phr. The rubber mixture preferably contains aluminium hydroxide as a reinforcing filler. The rubber mixture can comprise chloroprene rubber as a base polymer.

### CROSS REFERENCE TO RELATED APPLICATIONS

This application is a national stage of International Application No. PCT/EP2020/087103, filed on Dec. 18, 2020, which claims priority to DE Patent Application No. 10 2019 135 450.1 filed Dec. 20, 2019, all of which is hereby incorporated by reference in its entirety.

### BACKGROUND

The invention relates to an article having a single- or multi-layered main body having elastic properties.

Articles of this type may be for example in the form of a vibration damper and/or a metal-rubber element. The article may preferably be an air spring bellows membrane and/or an air spring bellows and/or a damping element of a mount and/or a conical spring and/or a sandwich mount.

Articles of this type are already known. Such an article is known for example from DE 10 2017 223 538 A1.

The article disclosed in DE 10 2017 223 538 A1 having elastic properties which is used for suspension/vibration damping in vehicles, in particular in rail vehicles, comprises a main body having elastic properties which comprises at least a layer D constructed from a rubber mixture containing at least one carbon black having a BET surface area according to DIN-ISO 9277 between 35 m²/g and 140 m²/g and an oil absorption number (OAN) according to ISO 4656 between 70 ml/100 g and 140 ml/100 g. Carbon blacks having the specified physical properties have the function of a reinforcing filler in elastomer mixtures.

Due to the ever-increasing demands on articles of the abovementioned type having regard to the fire safety properties to be fulfilled, resulting for example from fire safety standard EN 45545, halogen-free flame retardants in combination with carbon blacks of the abovementioned type are increasingly being added to rubber mixtures in order to allow elastomers produced therefrom to be made fire resistant.

It was thus recognized, for example in DE 10 2017 223 538 A1, that the fire characteristics of rubber mixtures may be improved by direct incorporation of, in some cases, relatively large amounts of flame retardant substances. However, in the mixtures affected this measure generally has the result of impairing the properties relevant for use in dynamic applications, such as tensile strength, elasticity, settling behavior and fatigue strength. In the articles affected this is especially apparent from the suspension, settling and vibration properties being significantly impaired. In addition, such articles exhibit poorer durability under high mechanical stresses and their maximum usage duration is therefore relatively shorter.

However, it has now been found that even the technical implementation described in DE 10 2017 223 538 A1 of an article of the abovementioned type still exhibits disadvantageous physical properties which result in relatively high wear and therefore above a size and usage duration also in insufficient suspension, settling and vibration properties, in particular for use of such articles in vehicle construction.

### BRIEF DESCRIPTION

Is accordingly an object of the present invention to provide an article of the abovementioned type which exhibits improved performance properties compared to the technical solution from DE 10 2017 223 538 A1.

This object is achieved by an article having the features as claimed in independent claim 1.

To achieve the abovementioned object it is possible to provide an article of the abovementioned type which is characterized in that at least one layer of the main body is constructed from a rubber mixture, wherein a carbon black proportion of at least one carbon black in the rubber mixture is less than 5 phr. It is preferable when the carbon black proportion is based on a total carbon black proportion of all carbon blacks in the rubber mixture. The rubber mixture may comprise no carbon black, one carbon black or more than one carbon black. The reduction of the carbon black proportion to below 5 phr has the advantage that the flammability of the main body is improved relative to a main body produced on the basis of the technical teaching of DE 10 2017 223 538 A1. It is thus possible to achieve a reduced flammability of the at least one layer since the carbon black proportion, a flammable proportion of the rubber mixture, is reduced relative to prior art compositions. In addition to the lower flammability the reduction of the carbon black proportion surprisingly results in higher breaking elongations, i.e. the material is more extensible. This has the advantage, especially in air spring bellows, that improved vibration damping properties and and increased service life are achievable.

Both DE 10 2017 223 538 A1 and the present invention have the objective of ensuring the best possible fire safety for metal-rubber elements. However, they follow opposite paths. While DE 10 2017 223 538 seeks to find a solution by retaining carbon blacks as fillers with a carbon black proportion of at least 5 phr and finding carbon blacks having particular flame retardant properties, the present invention follows the path, through reduction of the carbon black proportion to less than 5 phr, of regarding carbon blacks as being expendable as fillers and replacing the filler characteristic with aluminum hydroxide.

Parts per hundred (phr) is used in the rubber industry to describe the mass fractions of the individual mixture constituents in a formulation of an elastomer mixture. These amounts are in each case based on 100 parts (by mass) of the base polymer or the base polymers (in polymer blends).

Described below are advantageous embodiments of the invention which may be combined individually or in combination with the features of other embodiments, optionally together with features of claim 1.

It can be particularly advantageous when the at least one layer covers a layer therebelow at least over a functional regional or completely. In particular, the at least one layer may therefore be uninterrupted/or gapless.

The aluminum hydroxide may have a proportion in the rubber mixture of 50 phr to 150 phr, in particular of 50 phr to 100 phr, in particular of 100 phr to 150 phr, preferably of 75 phr to 125 phr.

The total carbon black proportion may be more than 0 phr or else 0 phr. The main difference between these two embodiments is that the carbon black can only achieve a color effect in the former case since the rubber mixture comprises no carbon black whatsoever in the latter case. Due to the very low carbon black proportion of less than 5 phr the carbon black in any case has no effect on the technical properties of the rubber mixture with the exception of the coloring. Said properties are therefore identical in both embodiments.

It may be provided that the rubber mixture has at least one colorant added to it. The colorant may be for example carbon black, iron oxide or titanium oxide. While carbon has a black coloring effect, iron oxide, for instance Bayferrox 920, often has a yellow coloring effect. Titanium dioxide may be used for color brightening. Red coloring may be achieved using Colortherm red 520 and a blue coloring effect using Oppasin blau 6900 for example. It may alternatively be provided that the rubber mixture is colorant-free. In this case the rubber mixture has no colorant added to it.

In an advantageous development it may be provided that the at least one carbon black, preferably all carbon blacks employed, in particular the carbon black added to the rubber mixture have a BET surface area according to DIN-ISO 9277 which is outside the range from 35 m²/g to 140 m²/g. Carbon blacks having a BET surface area according to DIN-ISO 9277 having a value of 35 m²/g to 140 m²/g are used as functional fillers for reinforcement in rubber mixtures. The present invention seeks to take a novel, alternative path to providing an article of the abovementioned type, wherein precisely the use of such reinforcing carbon black fillers may be reduced or the use of carbon blacks having a BET surface area according to DIN-ISO 9277 having a value of 35 m²/g to 140 m²/g may even be completely avoided. In DE 10 2017 223 538 A1 the addition of such carbon blacks is considered an essential feature of the technical teaching described therein. However, it is possible to add carbon blacks of other types, i.e. having a BET surface area according to DIN-ISO 9277 outside the range from 35 m²/g to 140 m²/g, in small amounts of less than 5 phr as a colorant. Carbon blacks outside the recited range in any case do not have any function as reinforcing filler but do have particularly good coloring properties for achieving black coloring of the rubber mixture.

In a further advantageous embodiment it may be provided that the at least one carbon black, preferably all carbon blacks employed, in particular the carbon black added to the rubber mixture, have an oil absorption number (OAN) according to ISO 4656 which is outside the range from 70 ml/100 g to 140 ml/100 g. Similarly to what is described in the preceding paragraph having regard to the BET surface area carbon blacks having an oil absorption number (OAN) according to ISO 4656 of 70 ml/100 g to 140 ml/100 g are also reinforcing carbon blacks. Since in the composition of the rubber mixture of the at least one layer a proportion of such reinforcing carbon blacks may be reduced or even entirely avoided the rubber mixture of the at least one layer includes carbon blacks having an oil absorption number (OAN) according to ISO 4656 of 70 ml/100 g to 140 ml/100 g only in small amounts of less than the 5 phr, if at all. The total carbon black proportion may therefore be kept particularly low to improve the mechanical properties of the article.

The rubber mixture of the at least one layer or all layers of the main body may comprise only one carbon black type or at least two or more carbon black types. A total carbon black proportion may be less than 5 phr or a carbon black proportion of a carbon black type having at least one of the above-described properties BET surface area according to DIN-ISO 9277 of 35 m²/g to 140 m²/g and/or oil absorption number (OAN) of 70 ml/100 g to 140 ml/100 g may be less than 5 phr.

A construction of an article, as described and claimed herein may be such that the main body has an inner elastomer layer, a middle functional layer and an outer elastomer layer. The articles often have an air chamber in which a positive pressure is generated in the usage position. In order to be able to achieve a long-term positive pressure inside the air chamber the inner elastomer layer facing the air chamber is particularly gastight, in particular airtight. The middle functional layer is used for force transfer and influences, for example through its construction, the vibration damping properties of the article. The outer layer protects the article from external influences, such as weathering, oil resistance, temperature resistance, fire protection. It may especially be provided that at least the outer elastomer layer and/or the inner elastomer layer has a carbon black proportion in an amount of less than 5 phr, preferably that all layers of the main body each have a carbon black proportion in an amount not less than 5 phr. The construction described makes it possible to achieve particularly high mechanical resilience and particularly good vibration damping.

In order to further improve mechanical resilience in may be provided in a further advantageous embodiment that the middle functional layer is in the form of a carcass, in particular wherein the carcass comprises a cord fabric embedded in at least one ply of an elastomer matrix. The abovementioned at least one layer may also be considered to be the abovementioned ply.

In a particularly preferred embodiment it may be provided that the at least one layer of the main body or the rubber mixture comprises a carbon black proportion comprising an amount of not more than 4 phr, in particular not more than 3 phr, in particular not more than 2 phr. The carbon black proportion may also be based on a total carbon black proportion of all carbon blacks present in the rubber mixture of the at least one layer. Such small amounts of carbon black do not influence the elastic/mechanical properties of the main body but are well suited to achieving black coloring of the main body of the article.

It may especially be provided that the total carbon black proportion in the rubber mixture is low enough to ensure that the elastic and/or mechanical properties of the main body are influenced only negligibly, if at all. An influence is negligible in particular when the particular technical properties are influenced to such a small extent that a person skilled in the art considers said influence to be irrelevant since these properties are specified through selection of the main components of the rubber mixture.

In order to form a layer of particularly low flammability it may be provided that the at least one layer of the main body is formed from chloroprene rubber or a blend of chloroprene rubber and another rubber or comprises chloroprene rubber or a blend of chloroprene rubber. The chloroprene rubber or the abovementioned blend may in particular form the base polymer of the rubber mixture. The at least one layer may in particular be the the outer elastomer layer. In a particularly preferred embodiment all layers of the main body may be produced from the same rubber mixture. Chloroprene rubber has particularly good fire characteristics for forming an article meeting the specified fire safety requirements.

In order to be able to improve smoke gas toxicity in the case of fire and simultaneously also mechanical properties of the article it has surprisingly proven advantageous for the at least one layer of the main body, in particular the rubber mixture, to comprise aluminum hydroxide (also referred to as “aluminum trihydrate” and abbreviated to ATH; empirical formula: Al(OH)₃) as reinforcing filler and/or as flame retardant. Aluminum hydroxide therefore assumes a twin function and it is thus surprisingly unnecessary to employ carbon blacks as reinforcing fillers in addition to ATH. The carbon blacks hitherto used as reinforcing fillers were thus able to be preferably completely substituted by ATH. It is thus not necessary for a rubber mixture to have ATH added to it as flame retardant and carbon black added to it as reinforcing filler, thus improving the elastic properties of the at least one layer of the main body. In other words a higher rubber proportion may be achieved relative to compositions where it has not been recognized that ATH can also assume the function of a reinforcing filler in addition to its flame retardant activity. In the reported quantity ratios 100 parts of the base polymer or the base polymers are always assumed. Based on this, a proportion of ATH in the rubber mixture of the at least one layer may be from 50 to 150 phr, in particular from 50 phr to 100 phr, in particular from 100 phr to 150 phr, preferably from 75 phr to 125 phr.

The at least one layer may preferably comprise exclusively aluminum hydroxide as reinforcing filler. In particular, the at least one layer may also be the outer elastomer layer or all layers of the main body.

In a particularly advantageous embodiment it may be provided that the article is a vibration damper and/or a metal-rubber element, preferably selected from the group of an air spring bellows membrane, an air spring bellows, a damping element of a mounting, a conical spring and/or a sandwich mount. It is particularly preferable when the article is an air spring bellows and/or an air spring bellows membrane.

The abovementioned object may therefore be achieved in particular by providing an article of the abovementioned type, wherein the article is an air spring bellows having a multi-layered main body having elastic properties, wherein the main body comprises an inner elastomer layer, a middle functional layer and an outer elastomer layer. It may be provided that the inner elastomer layer, the functional layer and the outer elastomer layer are constructed from an identical rubber mixture, that the rubber mixture comprises aluminum hydroxide as reinforcing filler and that a total carbon black proportion of all carbon blacks in the rubber mixture is less than 5 phr. The rubber mixture preferably comprises chloroprene rubber or a blend with such a rubber.

In the case of air spring bellows at most the outer elastomer layer, if any, is used as a fire safety cover layer while, by contrast, the rubber matrix of the functional layer contains special rubber mixtures which do not ensure fire safety. The particular advantage of the above-described solution is that all three layers of the air spring bellows are made of an identical, aluminum trihydroxide-containing mixture to provide a continuously homogeneous rubber matrix. It was recognized that the resulting air spring bellows surprisingly meets fire safety requirements of the highest level. The use of a homogeneous rubber matrix is advantageous for several reasons. Economic advantages resulting from simplification of production of the bellows are accompanied by technical advantages since, for example, the layers may be optimally crosslinked with one another.

The air spring bellows typically comprises two beads. These allow joining to attachable components. The beads may in each case be reinforced with a bead core. The beads may be joined via an air spring membrane. This typically consists of the inner elastomer there for securing airtightness, of the outer elastomer layer for protection from environmental influences and from the functional layer. The functional layer regularly comprises a cord fabric as a strength member and an elastomer matrix for embedding the cord fabric and for crosslinking the functional layer with the inner and outer layer. The function of the air suspension is substantially realized by an airtightly sealed air chamber operated under superatmospheric pressure.

The abovementioned object is additionally achieved by a process having the features of the coordinate process claim.

The object may therefore be achieved by providing a process for producing an article having a single- or multi-layered main body having elastic properties, in particular as described and/or claimed herein, from a rubber mixture, wherein aluminum hydroxide is added to the rubber mixture as reinforcing filler and at least one carbon black is added to the rubber mixture as colorant. It is therefore possible to form an article having improved mechanical properties from DE 10 2017 223 538 A1 which also meets the fire safety requirements according to the fire safety standard EN 45545.

The abovementioned object may therefore be achieved in particular by providing a process for producing an air stream bellows having a multi-layered main body having elastic properties, wherein the main body comprises an inner elastomer layer, a middle functional layer and an outer elastomer layer. It may be provided that the inner elastomer layer, the functional layer and the outer elastomer layer are produced from an identical rubber mixture, that aluminum hydroxide is added to the rubber mixture as reinforcing filler and that a total carbon black proportion of all carbon blacks in the rubber mixture is less than 5 phr. The air spring bellows is preferably configured as described hereinabove and/or according to any of the claims directed to such a bellows. As described hereinabove the total carbon black content may be 0 phr or more than 0 phr.

It is preferable when chloroprene rubber or a blend of chloroprene rubber is added to the rubber mixture, especially as the base polymer.

It is further preferably provided that at least one colorant is added to the rubber mixture. Said colorant may be as described hereinabove for example. In particular, addition of precisely one colorant, a plurality of colorants and/or a mixture of colorants is possible. It may alternatively be provided that the rubber mixture is colorant-free. In this case the rubber mixture has no colorant added to it.

The abovementioned object is additionally achieved by the use according to the coordinate use claim.

The object may be achieved by proposing the use of aluminum hydroxide as reinforcing filler in a rubber mixture, in particular for forming at least one layer of a main body, preferably of a main body of an article as described and/or claimed herein. The use of ATH instead of carbon black as filler allows the rubber proportion necessary for forming the elastic property to be higher than in the solution from DE 10 2017 223 538 A1.

The invention may also provide for a use of aluminum hydroxide as reinforcing filler in a rubber mixture for forming a main body of an air spring bellows, in particular wherein the air spring bellows is configured as described hereinabove or according to any of the claims directed to such a bellows.

The invention will now be explained in more detail on the basis of a plurality of exemplary embodiments without however being restricted to these exemplary embodiments. Further exemplary embodiments arise by combining the features of individual claims or of a plurality of claims among themselves and/or with individual features or a plurality of features of the exemplary embodiments.

### BRIEF DESCRIPTION OF THE DRAWINGS

In the figures:

FIG. 1 shows a longitudinal section through a possible variant of an inventive article, which is here in the form of an air spring bellows, wherein the arrow refers to a detailed view of a section through the layers of the main body of the air spring bellows membrane,

FIG. 2 is a perspective view of a possible variant of an article which is in the form of an air spring bellows membrane.

### DETAILED DESCRIPTION

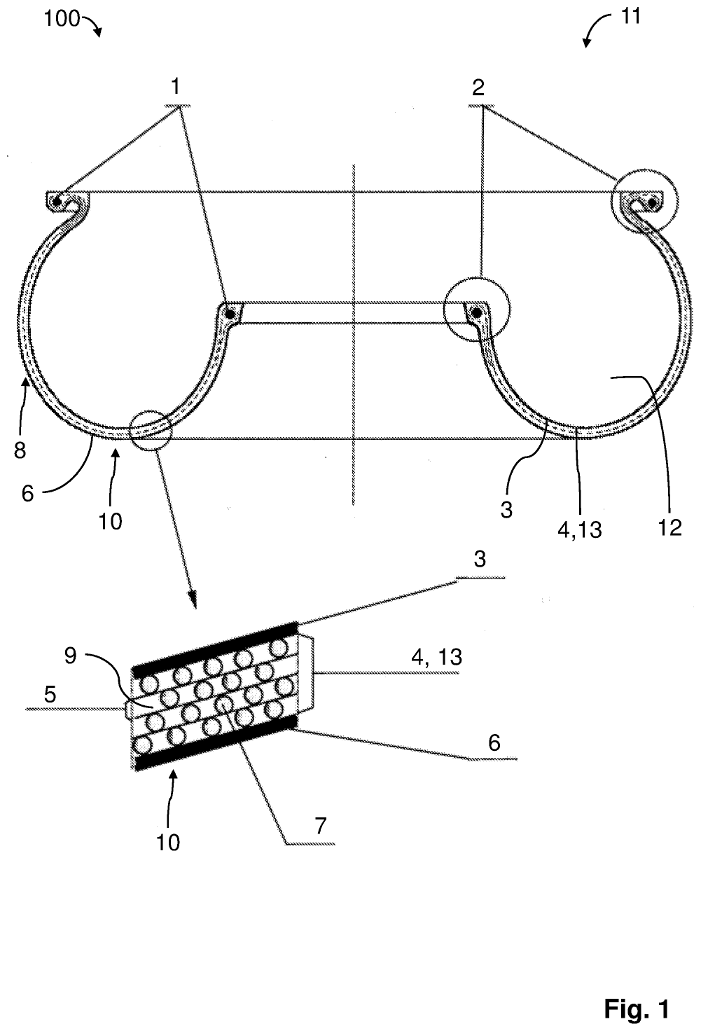

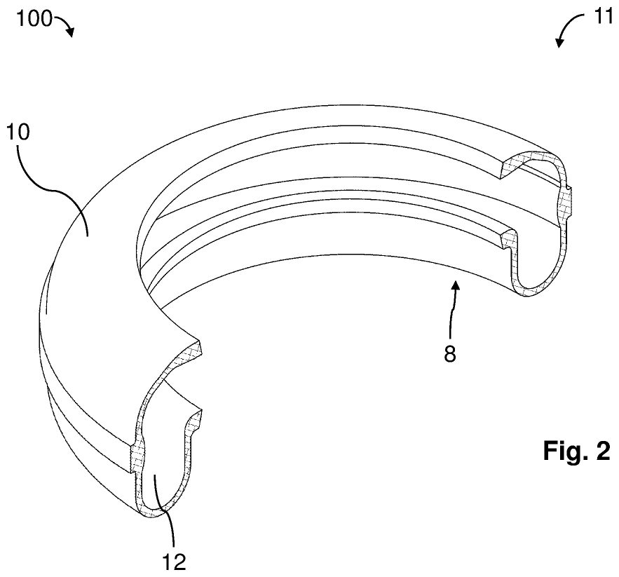

FIGS. 1 and 2 each show an article which is as a whole referred to as 100, wherein the working examples shown show an air spring bellows 11 and an air spring bellows membrane 10.

Article 100 comprises at least a main body 8 which is elastic at least in part and is therefore deformable.

The main body 8 at least partially delimits an air chamber 12.

Article 100 may further comprise at least two reinforcing elements, in particular made of metal, which may be in the form of metal cores for example. The reinforcing elements may be adapted for joining, in particular by screw connection and/or clamping and/or push-fitting, the article to further components.

The article 100 comprises two beads 2 which are each reinforced by a bead core 1. The air spring bellows membrane 10 extends between the two beads 2 and forms on its inside an air chamber 12.

The main body 8 is constructed from a plurality of layers 3, 4, 5, 6, 9 which may be at least partially or completely crosslinked with one another to form a composite element. This can especially prevent relative motion between the individual layers 3, 4, 5, 6, 9.

At least one layer 3, 4, 5, 6, 9 of the main body 8 is formed from a rubber mixture having a carbon black proportion, in particular total carbon black proportion, of less than 5 phr. It may be provided that all layers are formed from that rubber mixture. As a consequence of being formed from the same rubber mixture the layers form a homogeneous rubber matrix.

The carbon black proportion may be for example a carbon black proportion of any carbon black or else of a carbon black having a BET surface area according to DIN-ISO 9277 of 35 m²/g to 140 m²/g an/or an oil absorption number (OAN) according to ISO 4656 of 70 ml/100 g to 140 ml/100 g.

An addition of carbon black is merely for the purpose of adding the carbon black as colorant to achieve black coloring of the main body 8. If the article 100 is to have a different coloring the carbon black may also be substituted by a different colorant. If coloring is to be dispensed with the carbon black/the colorant may be omitted. This does not alter the elastic and mechanical properties of the rubber mixture.

The main body 8 comprises an inner elastomer layer 3, a middle functional layer 4 and an outer elastomer layer 6. In particular at least the outer elastomer layer 6 and/or the inner elastomer layer 3 may comprise a carbon proportion in an amount of less than 5 phr. It is preferable when all layers 3, 4, 5, 6, 9 of the main body 8 each have a carbon black proportion in an amount of less than 5 phr.

The middle functional layer 4 may be in the form of a carcass 13. In the variant shown the middle functional layer 4 comprises at least one cord fabric 7 which is in each case embedded in two or more plies 5 of an elastomer matrix 9. The elastomer matrix 9 may be formed from two or more plies 5 of the rubber mixture further described hereinabove and hereinbelow.

The at least one layer 3, 4, 5, 6, 9 may comprise chloroprene rubber or a blend of chloroprene rubber and another rubber as the rubber component. The rubber component is preferably made exclusively of chloroprene rubber.

The rubber mixture of the at least one layer 3, 4, 5, 6, 9 further comprises aluminum hydroxide as reinforcing filler, wherein aluminum hydroxide also functions as flame retardant. What is novel here is especially the surprising finding that aluminum hydroxide can replace carbon black as reinforcing filler. Aluminum hydroxide thus has a dual function as flame retardant and as reinforcing filler. In particular, the rubber mixture may include an amount of ATH of 50 phr to 150 phr, in particular of 60 phr to 140 phr, in particular of 70 phr to 130 phr.

The at least one layer 3, 4, 5, 6, 9 is preferably at least the outer elastomer layer 6.

In addition to being in the form of an air spring bellows membrane 10 and/or air spring bellows 11, the article 100 may be in the form of a vibration damper and/or a metal-rubber element. The article 100 may in particular be in the form of a damping element of a mounting and/or a conical spring and/or a sandwich mount.

It is generally the case that a reinforcing filler makes it possible to produce a particle-filled polymer, wherein an increase in elastic modulus is achieved according to a filler volume fraction. It is therefore necessary that a certain proportion of such fillers is used in the production of elastomers to adjust hardness, abrasion resistance and crack resistance characteristics.

1-17. (canceled)

18. An air spring bellows (100) having a multi-layered main body (8) having elastic properties, the main body (8) comprising:
an inner elastomer layer (3);
a middle functional layer (4); and
an outer elastomer layer (6);
wherein the inner elastomer layer (3), the middle functional layer (4) and the outer elastomer layer (6) are constructed from an identical rubber mixture, in that the rubber mixture comprises aluminum hydroxide as reinforcing filler and in that a total carbon black proportion of all carbon blacks in the rubber mixture is less than 5 phr; and
wherein the middle functional layer (4) is in the form of a carcass (13) comprising a cord fabric (7) embedded in at least one ply (5) of an elastomer matrix (9).

19. The air spring bellows (100) of claim 18, wherein the aluminum hydroxide has a proportion in the rubber mixture of 50 phr to 150 phr, in particular of 50 phr to 100 phr, in particular of 100 phr to 150 phr, preferably of 75 phr to 125 phr.

20. The air spring bellows (100) of claim 18, wherein the total carbon black proportion is 0 phr.

21. The air spring bellows (100) of claim 18, wherein the total carbon black proportion is more than 0 phr.

22. The air spring bellows (100) of claim 18, wherein the rubber mixture has at least one colorant added to it, in particular wherein the at least one colorant is a carbon black, an iron oxide or a titanium dioxide.

23. The air spring bellows (100) of claim 18, wherein the carbon black added to the rubber mixture has a BET surface area according to DIN-ISO 9277 which is outside the range from 35 m² /g to 140 m² /g, and/or the carbon black added to the rubber mixture has an oil absorption number (OAN) according to ISO 4656 which is outside the range from 70 ml/g to 140 ml/g.

24. The air spring bellows (100) of claim 18, wherein the total carbon black proportion of all carbon blacks in the rubber mixture is not more than 4 phr, in particular not more than 3 phr, in particular not more than 2 phr.

25. The air spring bellows (100) of claim 18, wherein the rubber mixture comprises chloroprene rubber or a blend of chloroprene rubber, in particular as the base polymer.

26. The air spring bellows (100) of claim 18, wherein the rubber mixture comprises exclusively aluminum hydroxide as reinforcing filler.

27. The air spring bellows (100) of claim 18, wherein the air spring bellows (100) is a vibration damper and/or a metal-rubber element and/or in that the air spring bellows (11) comprises an air spring bellows membrane (10).

28. A process for producing an air spring bellows (100) having a multi-layered main body (8) having elastic properties, wherein the main body (8) comprises an inner elastomer layer (3), a middle functional layer (4) and an outer elastomer layer (6), wherein the inner elastomer layer (3), the functional layer (4) and the outer elastomer layer (6) are produced from an identical rubber mixture, in that aluminum hydroxide is added to the rubber mixture as reinforcing filler and in that a total carbon black proportion of all carbon blacks in the rubber mixture is less than 5 phr.

29. The process of claim 28, wherein chloroprene rubber or a blend of chloroprene rubber is added to the rubber mixture, especially as the base polymer.

30. The process of claim 28, wherein at least one colorant is added to the rubber mixture, in particular wherein the at least one colorant is a carbon black, an iron oxide or a titanium dioxide.

31. The process of claim 28, wherein no carbon black is added to the rubber mixture.

32. Use of aluminum hydroxide as reinforcing filler in a rubber mixture for forming a main body (8) of an air spring bellows (8), wherein the air spring bellows (8) is configured according to claim 18.
